(19) United States
(12) Patent Application Publication
(10) Pub. No.: US 2011/0115388 A1
(43) Pub. Date: May 19, 2011

(54) LIGHT-EMITTING DIODE LIGHTING DEVICE WITH REGULATED POWER SUPPLY CIRCUIT

(75) Inventors: Yves SONTAG, BORDEAUX (FR); Laurent CANAL, MERIGNAC (FR)

(73) Assignee: THALES, NEUILLY SUR SEINE (FR)

(21) Appl. No.: 12/947,542

(22) Filed: Nov. 16, 2010

(30) Foreign Application Priority Data
Nov. 17, 2009 (FR) 09 05516

(51) Int. Cl. H05B 37/02

(52) U.S. Cl. 315/185 R

(57) ABSTRACT

The invention relates to lighting devices with light-emitting diodes organized in ramps arranged in parallel, each ramp including a certain quantity of light-emitting diodes arranged in series, the ramps being powered by a DC voltage of several tens of volts, called high voltage, the high voltage being generated by a step-up converter circuit from a low DC voltage of a few volts. The value of the voltage is controlled by the duty cycle of the step-up converter circuit, and the voltage is servocontrolled to a constant average value by a servocontrol device controlling the duty cycle. Each servocontrol device has several operating modes defined by a particular electronic addressing of the high voltage or by a defined number of ramps of lit diodes. To optimize the operation of the lighting device, the step-up converter circuit has discontinuous conduction and the servocontrol device includes several servocontrol electronic circuits linked to an electronic multiplexer, and each servocontrol electronic circuit being dedicated to a particular operating mode, the electronic characteristics of the servocontrol electronic circuits depending on the operating mode. The servocontrol electronic circuit is operational only when the operating mode is selected.

### CROSS-REFERENCE TO RELATED APPLICATION

This application claims priority to foreign French patent application No. FR 09 05516, filed on Nov. 17, 2009, the disclosure of which is incorporated by reference in its entirety.

### FIELD OF THE INVENTION

The field of the invention is that of light-emitting diode lighting used to light liquid crystal matrix imagers. The invention relates more particularly to lighting that has to have both a very wide dynamic range and a very high level of luminance.

### BACKGROUND OF THE INVENTION

This type of lighting is notably used in aeronautics to light the micro-imagers of the headset visors that have to be able to be used in daytime as at night. For this type of application, the lighting must have the following characteristics:
have an extremely small footprint, which prevents the use of passive electronic components such as high capacitance electrochemical capacitors;
implement a very large number of diodes (several hundred) so as to ensure the necessary luminance level;
provide a time scan of the diode power supply synchronized on the vertical scan of the video image applied to the matrix imager so that the lighting of the diodes can be synchronized on the video scan;
have a very wide luminosity dynamic range. To ensure this dynamic range, the diodes are lit for a certain period of a cycle. At the minimum of light, it can be demonstrated that the lighting time should not exceed one to two microseconds.

Generally, the diodes are organized in a matrix of N ramps each comprising M diodes, N and M being greater than one. Hereinafter in the description, the ramps are referenced Rᵢ, i being an index varying from 1 to N and the diodes are referenced Dⱼ, j being an index varying from 1 to M. To produce the lighting of the matrix, several power supply solutions have been proposed.

A first solution explained in FIG. 1 consists in using an electrical power supply for each ramp R, the power supply controlling M diodes Dj arranged in series. Each power supply includes a step-up circuit, also called “booster” 20. This circuit 20 is powered by a low DC voltage VIN through an inductance 30 and controlled by a control of PWM type, PWM being an acronym for “Pulse Width Modulator”. As an example, the circuit of reference ISL97634 from the company INTERSIL® can be used as “booster”. Reference should be made to the technical information sheet “Data Sheet FN6234.3 dated March 2008” from this company for all technical information concerning this circuit. This first solution unfortunately leads to an excessive footprint inasmuch as it requires N step-up circuits 20 to drive N ramps R of M diodes Dj.

A second solution is to use a single high voltage step-up converter delivering a voltage V_{HT}, each ramp being driven by a regular step-down chopping circuit, called “buck”. As for the preceding solution, N inductances are necessary, but they are much weaker because their current has a value close to the current of the diodes and the value of the fairly high HF switching duty cycle, around 90%. This solution is still not satisfactory in terms of footprint.

A third solution consists in mounting the ramps 10 in parallel. This solution is illustrated in FIG. 2. The ramps of diodes Ri are powered by a single voltage V^{HT}. Since the forward voltages of the diodes are not exactly equal, the voltages of the ramps Rᵢ are not strictly identical. To appropriately balance the currents, current sources Cᵢ that are independent of the voltage must be used. The nominal voltage at the terminals of these sources corresponds to a power that is lost. It is therefore essential that they should have a value that is just sufficient in the worst case.

An exemplary mounting of this type is represented in FIG. 3. In order to ensure the “dimming” of the light box, the current sources Cᵢ must be switched in time with a duty cycle depending on the required luminance by means of a “dimming” control DIM, driving transistors Tᵢ of “MOS” type. In the case of a light box without time scanning, all the transistors Tᵢ can have the same control. The collector-emitter voltage V_{CE} of the bipolar transistors Tᵢ must not exceed a few volts, but must be sufficient to support the disparity in the voltages between the various ramps Rᵢ. To obtain this, the voltage is measured on the collectors of the transistors and the power supply voltage V_{HT} of the ramps is servocontrolled accordingly. However, this can work correctly only if the voltage V_{HT} is correctly regulated dynamically and its ripple is of reasonable value. The diagram of FIG. 3 in which all the ramps have an independent control allows for any time scanning combination, one to N ramps being able to be lit simultaneously.

FIG. 4 represents an exemplary complete electronic embodiment of a lighting device of this type. In this diagram, three units each comprising six ramps R of diodes D are driven by an electronic circuit of FPGA (Field-Programmable Gate Array) type. The complete electronic circuit comprises six main sets framed by a dotted line rectangle in FIG. 4 and which are:
a programmable logic circuit 100 of FPGA type which controls the main functions of the lighting device;
three lighting units 110 each comprising six ramps R of diodes D, the six ramps being arranged in parallel;
a “DCM” circuit 120 of step-up converter type generating the high power supply voltage;
a vacuum servocontrol circuit 130 for this high power supply voltage;
a first “dimming” circuit 140 with six independent controls making it possible to simultaneously drive a ramp of each lighting unit, or, in total, to light three ramps simultaneously;
a second dimming circuit 150 with three controls making it possible to drive one and only one ramp of each lighting unit.

This diagram therefore allows for two operating modes: three ramps lit simultaneously or just one ramp at a time. This arrangement makes it possible to divide the number of transistors and control signals by two to produce the current sources.

As previously explained, the voltage VHT must be controlled to the nearest volt in order to be able to minimize the voltage at the terminals of the transistors of the current sources. The voltage V_{HT} must not be subject to transient variations during switching of the charge current during the “dimming” of the diodes. The conventional solution to this problem consists in engineering the capacitor C_{HT} for filtering the voltage V_{HT} to a value such that the step-up converter no longer senses the charge variations. This is the a priori natural solution for applications in which the volume is not critical and in which it is not prohibited to use capacitors of several hundreds of microfarads with a service voltage greater than 100 volts. In this case, it is possible to use a conventional “current mode” control integrated circuit for the step-up converter and the converter regulation loop is very slow. In the case of an architecture with a converter for each ramp of diodes, the best custom integrated circuits on the market make it possible to dispense with a high capacitor value as has already been explained. However, for some applications, the lighting source must necessarily have an extremely small footprint, which prohibits both the use of passive electronic components such as high capacitance electrochemical capacitors and the multiplication of step-up circuits.

### SUMMARY OF THE INVENTION

The diode lighting device according to the invention does not present these drawbacks. In practice, the electronic circuit controlling the voltage source is based on the combination of two main characteristics which are:
the obtaining of the high voltage by a step-up converter with discontinuous conduction, called DCM;
individualized servocontrol for each charge mode by dedicated servocontrol circuit.

Thus, by virtue of this individualized servocontrol and the particular response of the step-up converter with discontinuous conduction DCM, it is possible to easily control the stability and the speed of the servocontrol for each mode, without having to use a custom integrated circuit with current loop and counter-ramp.

More specifically, the subject of the invention is a light-emitting diode lighting device, said light-emitting diodes being organized in a first plurality of ramps arranged in parallel, each ramp comprising a second plurality of light-emitting diodes arranged in series, said ramps being powered by a DC voltage of several tens of volts, called high voltage, said voltage being generated by a step-up converter circuit from a low DC voltage of a few volts, the value of said voltage being a function of the duty cycle of the step-up converter circuit, said voltage being servocontrolled to a constant average value by means of an essentially analogue servocontrol device controlling said duty cycle, said servocontrol device having several operating modes, a mode being defined either by a particular electronic addressing of the high voltage, or by a defined number of ramps of lit diodes, characterized in that the step-up converter circuit has discontinuous conduction and that the servocontrol device comprises several servocontrol electronic circuits linked to an electronic multiplexer, each servocontrol electronic circuit being dedicated to a particular operating mode, the electronic characteristics of said servocontrol electronic circuits depending on said operating mode, said servocontrol electronic circuit being operational only when the operating mode is selected.

Advantageously, the servocontrol device comprises means of memorizing the various duty cycles dedicated to each operating mode.

Advantageously, when the servocontrol device is produced in analogue technology, each servocontrol electronic circuit comprises an operational transconductance amplifier, called OTA, an activation control and an integration circuit arranged in series.

Advantageously, the gain of the operational transconductance amplifier of each servocontrol electronic circuit depends on the operating mode to which said servocontrol electronic circuit is dedicated and the various integration circuits of the various electronic circuits are all identical.

Advantageously, the first plurality of ramps is structured in a first number N of ramp units, each unit comprising a second number M of ramps, the lighting of the diodes that make up the ramps being controlled in a matrix manner by two control circuits, also called “dimming” circuits, the first circuit comprising N first control means, each first control means making it possible to simultaneously control one and only one ramp of all the ramp units, the second circuit comprising M second control means, each second control means making it possible to simultaneously control all the ramps of one and only one unit.

The invention also relates to a light-emitting diode lighting device, said light-emitting diodes being organized in a first plurality of ramps arranged in parallel, each ramp comprising a second plurality of light-emitting diodes arranged in series, said ramps being powered by a DC voltage of several tens of volts, called high voltage, said voltage being generated by a step-up converter circuit from a low DC voltage of a few volts, the value of said voltage being controlled by the duty cycle of the step-up converter circuit, characterized in that said voltage is servocontrolled to a constant average value by means of an essentially digital servocontrol device controlling said duty cycle, said servocontrol device having several operating modes, a mode being defined either by a particular electronic addressing of the high voltage, or by a defined number of ramps of lit diodes, the step-up converter circuit “having discontinuous conduction”.

### BRIEF DESCRIPTION OF THE DRAWINGS

The invention will be better understood and other advantages will emerge from reading the following description given as a nonlimiting example and by virtue of the appended figures in which:

FIG. 1 represents a first lighting device according to the prior art comprising a single ramp of light-emitting diodes, said diodes being arranged in series;

FIGS. 2 and 3 represent a second lighting device comprising several ramps of light-emitting diodes, said ramps arranged in parallel;

FIG. 4 represents a detailed electronic diagram of a second lighting device comprising 18 ramps of light-emitting diodes;

FIG. 5 represents, in an analogue embodiment, the principle of electrical power supply and of its servocontrolling of a lighting device with ramps of light-emitting diodes according to the invention;

FIG. 6 represents the electronic diagram of a step-up converter circuit according to the invention;

FIG. 7 represents the electronic diagram of a servocontrol device according to the invention;

FIG. 8 represents the various gains of the electronic servocontrol loop according to the invention;

FIG. 9 represents the value of these various gains as a function of the frequency; and

FIG. 10 represents, in a digital embodiment, the principle of electrical power supply and of its servocontrolling of a lighting device with ramps of light-emitting diodes according to the invention.

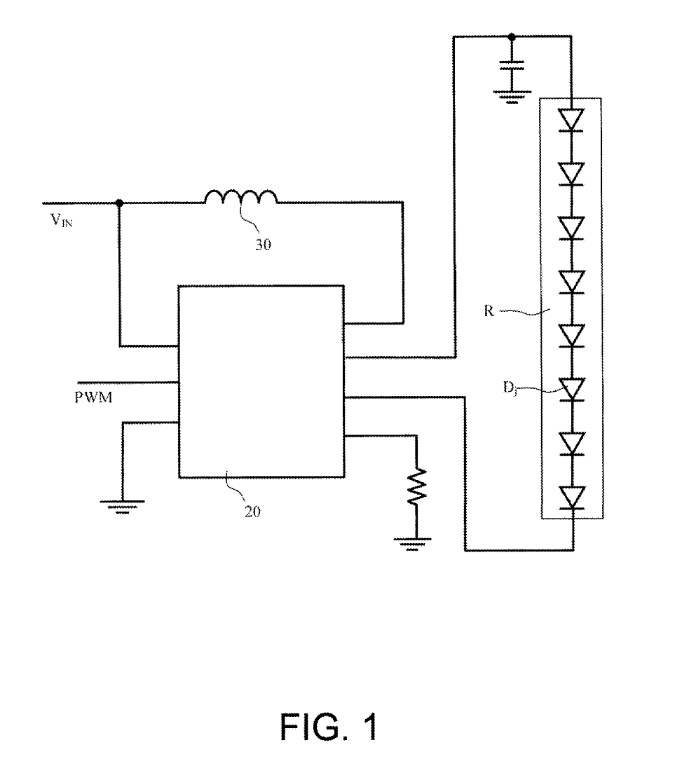

### DETAILED DESCRIPTION

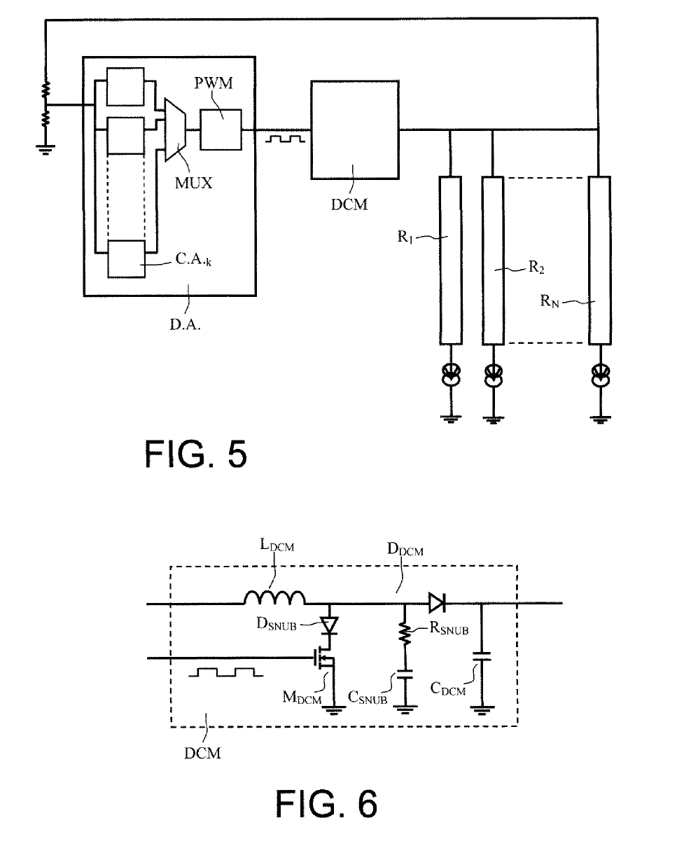

The light-emitting diode lighting devices affected by the invention and as illustrated in FIG. 5 comprise a first plurality of ramps Rᵢ, said ramps being arranged in parallel, each ramp comprising a second plurality of light-emitting diodes Dⱼ arranged in series, said ramps being powered by a DC voltage V_{HT} of several tens of volts, called high voltage, said voltage being generated by a step-up converter circuit DCM from a low DC voltage of a few volts, the value of said voltage V_{HT} being controlled by the duty cycle of the step-up converter circuit, said voltage being servocontrolled to a constant average value by means of a servocontrol device controlling said duty cycle supplied by a control circuit of PWM type, PWM being an acronym for “Pulse Width Modulator”, said servocontrol device having several operating modes Mₖ, a mode Mₖ being defined either by a particular electronic addressing of the high voltage, or by a defined number of ramps of lit diodes. One particular feature of a light-emitting diode lighting device comprising several ramps mounted in parallel is that the charge current is known. In practice, there are a finite number K of operating modes Mₖ. Thus, a first mode M₁ may correspond to one ramp operating Rᵢ, a second mode M₃ to three ramps operating, a third mode M₀ to no diode conducting at a given moment with a known amplitude value. As an example, there are typically three charge modes:
mode M₁, called “3 ramps”: three ramps of diodes are lit simultaneously with the nominal diode current;
mode M₃, called “1 ramp”: a single ramp is lit with an attenuated diode current;
mode M₀, called “almost empty”, that is to say that the voltage V_{HT} is controlled by a resistance bridge which lightly charges the converter and requires its operation. The almost empty mode facilitates the starting up of the converter and enables the output voltage to be supervised.

However, other modes can be added:
“zero current” mode with the resistance bridge of the high power supply voltage V_{HT} disconnected. In this mode, the step-up converter circuit is off. This mode is preferable to the “almost empty” mode for a low light application working on batteries;
modes comprising other possible combinations of the number of ramps with current intensities in the diodes that are equal to or different from the nominal intensity.

The light-emitting diode lighting device according to the invention uses this particular feature. In practice, as represented in FIG. 5, the servocontrol device comprises several servocontrol electronic circuits CAₖ linked to an electronic multiplexer MUX, each servocontrol electronic circuit CAₖ being dedicated to a particular operating mode Mₖ, the electronic characteristics of said servocontrol electronic circuits depending on said operating mode, said servocontrol electronic circuit being operational only when the operating mode is selected. Furthermore, in the device according to the invention, the step-up converter has discontinuous conduction.

Each of these operational modes has a corresponding servocontrol loop which controls the duty cycle of the step-up converter, symbolized by the small pulses in FIG. 5. On leaving a mode, the value of the corresponding duty cycle is memorized. This makes it possible to immediately establish the correct duty cycle on returning to the mode concerned.

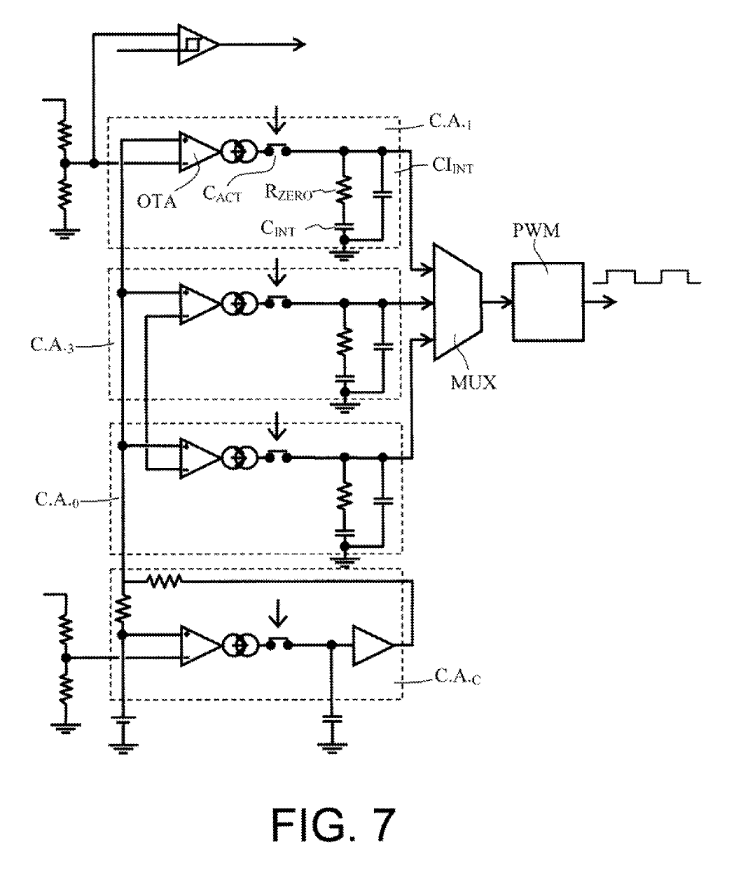

As an example, FIG. 7 represents an electronic diagram of an assembly comprising three servocontrol circuits CA₁, CA₃ and CA₀. These circuits are dedicated to three operating modes which may be the so-called “3 ramps”, “1 ramp” and “almost empty” modes as described previously. As indicated in FIG. 7, each servocontrol electronic circuit comprises an operational transconductance amplifier, called “OTA”, an activation control C_{ACT} and an integration circuit CI_{INT} arranged in series. The activation controls select the servocontrol circuit corresponding to the selected operating mode. Each integration circuit includes an integration capacitor denoted C_{INT} and a resistor denoted R_{ZERO} arranged in series. It can be shown that the time constants may be the same for all three servocontrol loops, only the gains denoted G_{M} of the transconductance amplifiers changing according to the mode M in order to optimize the bandwidth and the stability of the loop. A simple formula gives the approximate value of the gains of the amplifiers to be corrected by simulation or trial and error for the empty mode in which the losses of the converter are totally preponderant. On power up, it is possible to force the empty mode for the time it takes for the voltage V_{HT} to be established. In overvoltage cases, the other modes are prohibited. When switching from one mode to the other, the duty cycle is immediately switched to the correct value previously delivered by the servocontrol.

It is known that, to appropriately balance the currents flowing in the diodes of the ramps, current sources C, that are independent of the voltage must be used. The analogue diagram of FIG. 7 also comprises a servocontrol circuit CA_{c} for the current sources comprising transistors Ti. The collector-emitter voltage V_{CE} of the transistors must not exceed a few volts, sufficient to withstand the disparity in the voltages between the various ramps Rᵢ. The collector voltage is adjusted by fine-tuning the voltage V_{HT} setpoint using an additional loop whose speed is unimportant given that the phenomena that have the greatest influence on the forward voltage of the diodes are the necessarily slow temperature variations. Also, only an action that can be integrated is useful for this loop.

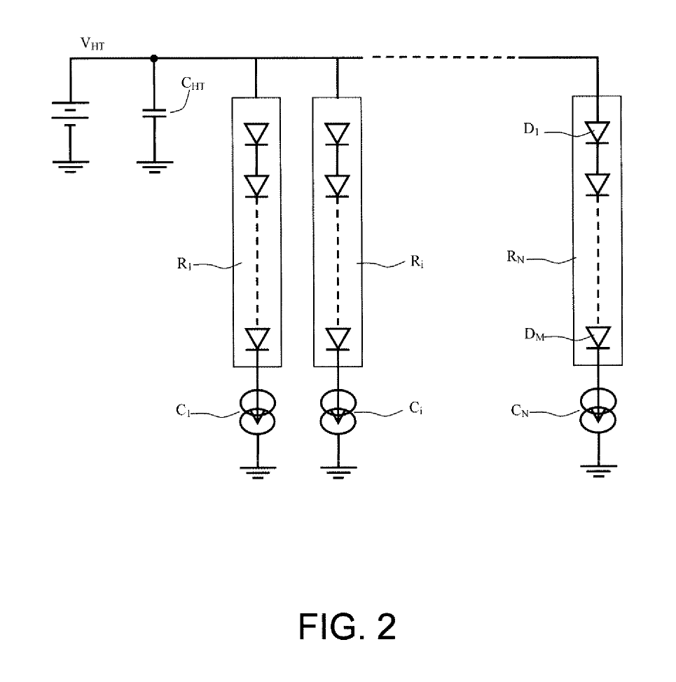

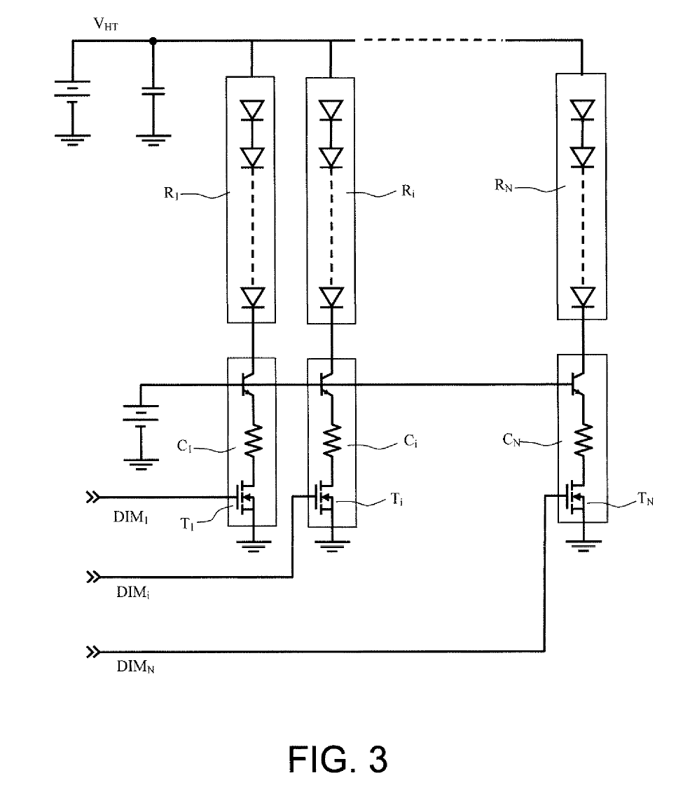

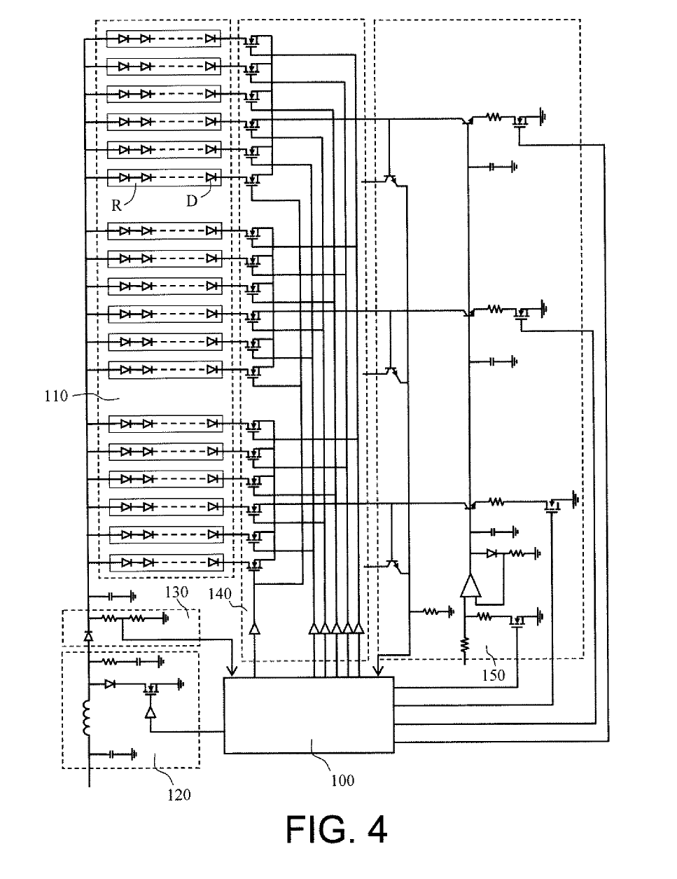

It is possible to imagine other regulation diagram variants; it is possible in particular to adapt the principle of the device according to the invention to a digital regulation. In the operating modes in which one or more ramps of diodes are activated, it is possible to directly servocontrol the converter from the measurement of the voltages of the collectors of the transistors without worrying about the voltage V_{HT}. In this type of architecture, in almost empty mode, apart from the power supply startup phase, the voltage V_{HT} must be servocontrolled to the value fine tuned in the other modes. The important thing is that the voltage VHT does not change significantly when changing mode to the nearest ripple on the capacitor C_{HT} (see FIG. 2).

As has been stated, the high voltage is obtained by means of a step-up converter with discontinuous conduction DCM. FIG. 6 represents the electronic diagram of such a step-up converter circuit. As indicated in this figure, it mainly comprises an inductance L_{DCM} arranged in series with a diode D_{DCM}, a charge capacitor C_{DCM}, a control transistor M_{DCM} driven by a signal of PWM type in the form of time pulses. It also comprises a network consisting of a resistor R_{SNUB} and a capacitor C_{SNUB} for dissipating the residual energy at end of cycle and a diode D_{SNUB} if necessary.

One of the main characteristics of the inventive device is the use of a discontinuous switching mode for the step-up converter DCM. In this switching mode, the energy stored in the inductance L_{DCM} is fully discharged before beginning a new cycle. At each cycle, the current restarts from zero. This switching mode is very marginally used and generally decried for the following reasons:
the peak amplitude of the current in the inductance is high, twice the average current;
the evacuation of the energy remaining in the inductance before initiating a new cycle requires a “damping” servocontrol circuit of RC type which adds losses.

In the particular case of the power supply for ramps of light-emitting diodes, the use of this switching mode makes it possible to achieve an efficiency that is more than appropriate, independently of the other benefits obtained by this solution.

In most DCM converter applications, the diode is almost never seen arranged in series with the control MOS transistor MDCM. The absence of the diode D_{SNUB} then allows this transistor to reconduct through its so-called “body” diode with several repeats during the dead time of the cycle, which does not favour the dissipation of the residual energy. Despite the low additional loss that it brings about, the diode D_{SNUB} allows for a more powerful and reproducible damping. At each start of cycle, the current is zero in the inductance, so what happens during a cycle no longer has any impact on the next. The advantage is the independent behaviour obtained from cycle to cycle. Thus, in a single cycle, it is possible to achieve a desired operating mode. This is of prime importance for the device according to the invention because a perfect switching from one charge mode to another is thus obtained without the voltage V_{HT} being disturbed.

Furthermore, one property of the DCM mode has particularly advantageous practical consequences. Its unit-step response, for example to a setpoint variation, is very close to a first order. This is, moreover, precisely true in small signals. The internal loop servocontrolling the current of the regulation integrated circuits of step-up converters that is usually obligatory with a CCM converter is no longer necessary in the case of the DCM. In practice, in the case of a CCM converter, if there was no internal current loop, the open loop transmittance of the power stage would be of the second order and the stability would be extremely difficult to obtain.

The regulation as described in FIGS. 6 and 7 is feasible in digital technology within a programmable logic circuit of FPGA type. This type of component is a priori already available to handle the control of the display microscreen lit by the light-emitting diodes of the lighting circuit. The FPGA has analogue resources, including an analogue-digital converter, or ADC. This converter generally works on 12 bits.

In small signals, the power stage of the DCM converter has a first order characteristic with a gain denoted G_{power} and a time constant denoted C_{power} which has a corresponding cutoff frequency denoted F_{power} for which the values can be determined by the following approximation formulae, by neglecting the losses:

G_{power}=dVHT/dTon˜Vin*(2*VHT/L1*Iout To)^{1/2}

C_{power}˜VHT C_{HT}/Iout

F_{power}˜Iout/(2*πVHT*C_{HT})

with
To: switching period;
Ton: conduction time of the transistor M_{DCM};
Vin: input voltage on L_{DCM};
Iout: current consumed on VHT.

In large signals, despite the nonlinear nature of the transfer function, a function of the square of Vin*Ton, the response of the DCM converter remains aperiodic and similar to a first order. The approximation formulae have sufficient accuracy to configure the regulation but it is possible, by digital simulation of the electronic circuit, to determine values closer to reality. As an example, it is possible to use the “SPICE” simulation software.

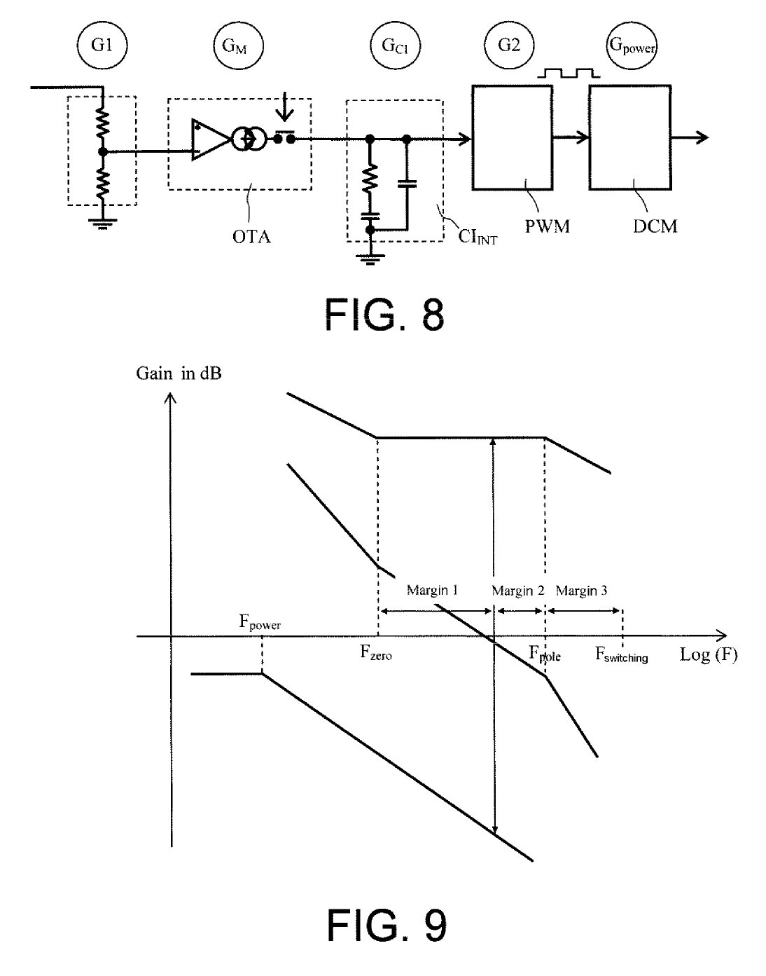

FIG. 8 shows, when an operating mode is operational, all of the power supply and servocontrol subsystem of the lighting device with the different gains, G1 being the gain of the resistance bridge of the servocontrol device, G_{M} being the gain of the transconductance amplifier, G_{CI} the gain of the integration circuit, G2 the gain of the PWM signal generation circuit and finally G_{power} being the gain of the converter. In FIG. 9, the different gains of this subsystem are represented as a function of the frequency.

Various frequency margins are necessary to the stability of the loop. First of all, it is essential for its gain to be very low at the switching frequency of the duty cycle. This is all the more essential in the case of a digital regulation, on the one hand because the sampling frequency of the signals does not exceed this value and, on the other hand, in order to minimize the microvariations in time of the switching duty cycle, or “jitter”, and makes the “electronic framing” function, better known as final “dithering”, more effective. The final filtering may be more powerful than a simple first order. The margins 2 and 3 must be sufficient to overcome the gain variations, and they should not be less than one octave.

Fpole HF=Fswitching/margin 1˜1/(2*πRzero*Chf) if Chf is smaller than Cint

BP=Fswitching/(margin1*margin2)

Fzero=Fswitching/(margin1*margin2*margin3)=1/(2*πRzero*Cint)

Frequency attenuation at BP=product of the steady-state gains

BP/Fpower=G1*G_{M}*Rzero*G2*G_{power}

The gain G_{M} as a function of the operating point or of the charge mode is deduced therefrom.

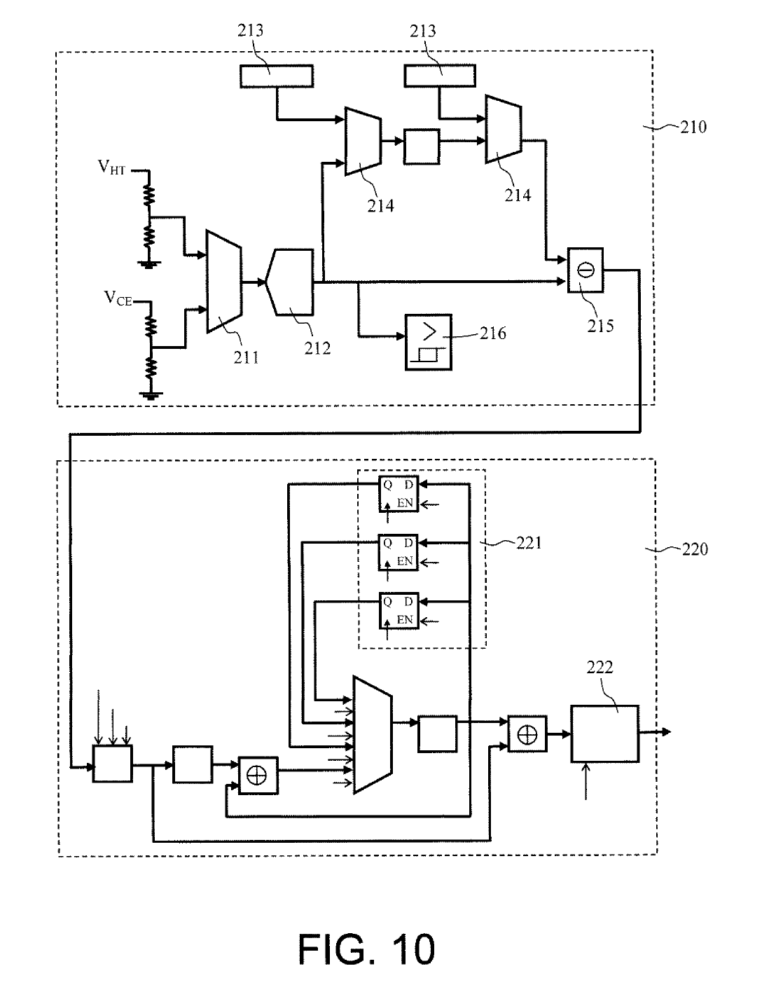

FIG. 10 represents an exemplary digital embodiment of a servocontrol device for the control voltages according to the invention. It mainly comprises two digital assemblies 210 and 220. The first assembly 210 calculates the error signal on the voltage levels V_{HT} and V_{CE}. The second assembly 220 is an integrator which drives the control signal generator for the step-up converter circuit which is not represented in this figure.

The first assembly 210 comprises a first multiplexer 211, an analogue-digital converter 212, a reference channel comprising the initial voltage setpoints 213 and two multiplexers 214, a comparator 215 making it possible to compare the values of the voltage setpoints to the measured values in order to deduce the error signal therefrom. This subsystem can also include a backup comparator 216.

The integrator assembly 220 comprises a state machine 221 which controls the various charge modes and the switching from one mode to the other. This machine is dependent on the luminosity setpoints of the microscreen, on the vertical video synchronization signal and on the initialization circuit. Unlike the analogue diagram, there are not as many integrators as there are modes, but just one with saving and recall of the integral values for each mode.

Fsw denotes the switching frequency of the converter and the sampling frequency of the ADC converter. Given the high ratio between the clock frequency Clk of the digital part and the switching frequency Fsw, some gain functions or multiplications may be performed sequentially with a single adder. This adds at least one Fsw latency for these blocks.

The high frequency filtering may be performed with a simple recursive filter 222 equivalent to an analogue low-pass filter. Although the ratio between the clock frequency Clk and the switching frequency Fsw is fairly high, to obtain an average time resolution that is finer than the clock period Clk, it is possible to add a time “dithering” device which simply involves carrying over the rounding error to the next cycle. The effectiveness of the “dithering” circuit is all the better if the signal has been filtered previously.

Since the digital assembly for calculating the error signal uses only a single ADC converter, its electronic diagram is a little different from its analogue equivalent.

As previously, the startup is performed in the so-called “almost empty” mode with a default initial VHT setpoint. As soon as operational operation is established, in the modes 2 or 3, the servocontrol is performed directly by measuring the voltage of the collectors of the transistors of the current sources. This servocontrol will bring the voltage VHT to a value different from the default value. In the mode 1, it is essential to keep the voltage VHT at this same value. The new setpoint is obtained by memorizing the VHT value at the moment of leaving the mode 2 or the mode 3.

In night use, the luminosity required is very low. Thus, the converter is in mode 1 for most of the time. The power consumed in this mode is mainly that of the losses of the converter circuit or “booster”. In this usage condition, the microscreen may be required to operate on batteries in certain circumstances. Thus, when the imager lit by the lighting device belongs to a headset display worn by a pilot, it is possible that the pilot may need to use his headset outside his aircraft. To minimize the consumption in this low luminosity mode, it is better to replace the mode 1 with a zero current mode such that the “booster” circuit is stopped with the charge of the VHT measurement bridge disconnected using an MOS type transistor. The mode 1 still retains its usefulness on power up because it allows for a naturally progressive startup that does not require any so-called “soft-start” ancillary circuit.

What is claimed is:

1. A light-emitting diode lighting device comprising light-emitting diodes, said light-emitting diodes being organized in a first plurality of ramps arranged in parallel, each ramp comprising a second plurality of light-emitting diodes arranged in series, said ramps being powered by a DC voltage of several tens of volts, called high voltage, said high voltage being generated by a step-up converter circuit from a low DC voltage of a few volts, the value of said voltage being controlled by the duty cycle of the step-up converter circuit, said voltage being servocontrolled to a constant average value by means of an essentially analogue servocontrol device controlling said duty cycle, said servocontrol device having several operating modes, a mode being defined by one of a particular electronic addressing of the high voltage, and a defined number of ramps of lit diodes,
wherein the step-up converter circuit has discontinuous conduction and the servocontrol device comprises several servocontrol electronic circuits linked to an electronic multiplexer, each servocontrol electronic circuit being dedicated to a particular operating mode, the electronic characteristics of said servocontrol electronic circuits depending on said operating mode, said servocontrol electronic circuit being operational only when the operating mode is selected.

2. The light-emitting diode lighting device according to claim 1, wherein the servocontrol device comprises means of memorizing the various duty cycles dedicated to each operating mode.

3. The light-emitting diode lighting device according to claim 1, wherein, when the servocontrol device is produced in analogue technology, each servocontrol electronic circuit comprises an operational transconductance amplifier, called OTA, an activation control and an integration circuit arranged in series.

4. The light-emitting diode lighting device according to claim 3, wherein the gain of the operational transconductance amplifier of each servocontrol electronic circuit depends on the operating mode to which said servocontrol electronic circuit is dedicated and in that the various integration circuits of the various electronic circuits are all identical.

5. The light-emitting diode lighting device according to claim 1, wherein the first plurality of ramps is structured in a first number N of ramp units, each unit comprising a second number M of ramps, the lighting of the diodes that make up the ramps being controlled in a matrix manner by two control circuits, called dimming circuits, the first circuit comprising N first control means, each first control means making it possible to simultaneously control one and only one ramp of all the ramp units, the second circuit comprising M second control means, each second control means making it possible to simultaneously control all the ramps of one and only one unit.

6. A light-emitting diode lighting device comprising light-emitting diodes, said light-emitting diodes being organized in a first plurality of ramps arranged in parallel, each ramp comprising a second plurality of light-emitting diodes arranged in series, said ramps being powered by a DC voltage of several tens of volts, called high voltage, said high voltage being generated by a step-up converter circuit from a low DC voltage of a few volts, the value of said voltage being controlled by the duty cycle of the step-up converter circuit, wherein said voltage is servocontrolled to a constant average value by means of an essentially digital servocontrol device controlling said duty cycle, said servocontrol device having several operating modes, a mode being defined either by a particular electronic addressing of the high voltage, or by a defined number of ramps of lit diodes, the step-up converter circuit having discontinuous conduction, each of said operating modes having a corresponding servocontrol loop which controls the duty cycle of the step-up converter circuit, the value of the duty cycle of the current operating mode being memorized before each change of said current mode.
